(19) United States
(12) Patent Application Publication
(10) Pub. No.: US 2024/0022954 A1
(43) Pub. Date: Jan. 18, 2024

(54) METHOD AND DEVICE FOR WIRELESS COMMUNICATION

(71) Applicants: Yu CHEN, SHANGHAI (CN); Xiaobo ZHANG, SHANGHAI (CN)

(72) Inventors: Yu CHEN, SHANGHAI (CN); Xiaobo ZHANG, SHANGHAI (CN)

(73) Assignee: SHANGHAI LANGBO COMMUNICATION TECHNOLOGY COMPANY LIMITED, Shanghai (CN)

(21) Appl. No.: 18/219,095

(22) Filed: Jul. 7, 2023

(30) Foreign Application Priority Data
Jul. 18, 2022 (CN) 202210842110.7

(51) Int. Cl. H04W 28/02; H04W 76/28

(52) U.S. Cl. CPC H04W 28/0278; H04W 28/0268; H04W 76/28

(57) ABSTRACT

The present application provides a method and device for wireless communications, comprising calculating a first data volume in a PDCP; transmitting a first buffer status report; wherein the first data volume is used for the first buffer status report; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment is used to determine the first data volume. The present application provides the possibility of transmitting richer and more complex services through the first operation and the second operation.

### CROSS REFERENCE TO RELATED APPLICATIONS

This application claims the priority benefit of Chinese Patent Application No. 202210842110.7, filed on Jul. 18, 2022, the full disclosure of which is incorporated herein by reference.

### BACKGROUND

### Technical Field

The present application relates to transmission methods and devices in wireless communication systems, and to a method and device for improving service quality and better supporting interactive service transmission, especially for XR services.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

### SUMMARY

Data volume calculation in the PDCP layer is an important function related to the generation or transmission of Buffer Status Reports (BSRs). In communication networks, especially in 5G or later communication networks, when a user terminal need to transmit data, and if there is no resource available, a BSR needs to be transmitted firstly. The BSR is used to trigger a base station to transmit scheduling information, the base station determines resources to be scheduled based on the BSR, and the user terminal can only transmit data when there are resources available. However, there is a certain delay from transmitting the BSR to receiving a scheduling signaling, therefore, if there is data with strict delay requirements to be transmitted and there is no resource, using a traditional BSR->to schedule the mechanism may result in exceeding the maximum allowed delay, which cannot meet QoS requirements. This is particularly important for interactive services, such as XR services. The XR services comprise VR (Virtual Reality) service, AR (Augmented Reality) service, and CG (Cloud Games) service, which have the characteristics of high speed and low latency, at the same time, they are interactive services and have strict requirements for service response time, such as when the user's gesture information is transmitted to the server, the feedback screen from the server needs to be presented on the user's terminal in a short period of time, otherwise the user's experience will be affected by feeling a significant delay. An XR service comprises various data, such as video, audio, and data used to control various sensors, which have certain dependencies. For example, receiving only videos targeting the left eye without receiving videos targeting the right eye cannot meet the requirements. Traditional service transmission may assume that at least half data has been received, but in XR service, receiving only videos targeting the left eye may be meaningless. These related data constitute a collection of data that needs to be processed together. These data that needs to be processed together can be one or multiple flows. Data with associated relations can be either uplink or downlink. The issue to be addressed in the present application comprises how to more appropriately determine a data volume to assist the MAC layer in transmitting a BSR. The method proposed in the present application can solve a variety of problems, which is not limited to interactive services or XR services.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
calculating a first data volume in a Packet Data Convergence Protocol (PDCP); and
transmitting a first BSR;
herein, the first data volume is used for the first BSR; any of a PDCP Service Data Unit (SDU) not constructed with a corresponding PDCP data Protocol Data Unit (PDU), a PDCP data PDU not submitted to a lower layer, a PDCP control PDU, a PDCP SDU of an Acknowledged Mode Data Radio Bearer (AM DRB) that will be retransmitted, and a PDCP data PDU of an AM DRB that will be retransmitted is included in only a former of the first data volume and a first adjustment amount, and the first adjustment amount is used to determine the first data volume.

In one embodiment, a problem to be solved in the present application comprises: how to determine a first data volume.

In one embodiment, advantages of the above method comprise: it is conducive to supporting richer services, ensuring the QoS requirements, enhancing the calculation of PDCP data volume, reducing service delay, and determining data volume more accurately.

Specifically, according to one aspect of the present application, the first adjustment amount is unrelated to both a PDCP SDU and a PDCP PDU in buffer.

Specifically, according to one aspect of the present application, what is included in the first adjustment amount comprises higher-layer data not arriving at a PDCP layer.

Specifically, according to one aspect of the present application, at least one of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is used to determine the first adjustment amount.

Specifically, according to one aspect of the present application, a first signaling is received, and the first signaling indicates a first sequence number threshold;
herein, a first PDCP data unit is a last PDCP data unit to be allocated a sequence number, a sequence number of the first PDCP data unit is a first sequence number, and the first adjustment amount comprises a data volume of a PDCP data unit not exceeding the first sequence number threshold after the first sequence number.

Specifically, according to one aspect of the present application, the first signaling indicates a first data volume threshold;
herein, the first adjustment amount comprises a data volume not exceeding the first data volume threshold.

Specifically, according to one aspect of the present application, a first PDCP data unit is a latest PDCP data unit, a sequence number of the first PDCP data unit is a first sequence number, the first adjustment amount comprises a data volume of K PDCP data unit(s) after the first sequence number, where K is a positive integer, and a value of K is related to a value of the first sequence number, when a value of the first sequence number increases, a value of K decreases.

Specifically, according to one aspect of the present application, first QoS information is received, and the first QoS information is for interactive services; the first QoS information is used to determine a first transmission time, and the first adjustment amount comprises an expected data volume of a PDCP data unit before the first transmission time.

Specifically, according to one aspect of the present application, the first transmission time is related to a next running of an onduration timer of a DRX.

Specifically, according to one aspect of the present application, a protocol layer above a PDCP of the first node indicates a first PDU set, and the first PDU set is used to determine the first adjustment amount; the first PDU set comprises at least one PDU unrelated to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted; the meaning of the phrase that a protocol layer above a PDCP of the first node indicates a first PDU set comprises: a protocol layer above a PDCP of the first node indicates a number of PDU(s) comprised in the first PDU set, or a protocol layer above a PDCP of the first node indicates a data volume of the first PDU set.

Specifically, according to one aspect of the present application, first scheduling information is received; on resources indicated by the first scheduling information, a first PDCP PDU set is transmitted; the first PDCP PDU set comprises at least a first PDCP PDU;
herein, a header of the first PDCP PDU comprises a first field and a second field, the first field indicates a sequence number of the first PDCP PDU, and the second field is used to indicate whether the first PDCP PDU belongs to a PDU set.

Specifically, according to one aspect of the present application, the first node is an IoT terminal.

Specifically, according to one aspect of the present application, the first node is a relay.

Specifically, according to one aspect of the present application, the first node is a base station.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a first node for wireless communications, comprising:
a first processor, calculating a first data volume in a PDCP; and
a first transmitter, transmitting a first BSR;
herein, the first data volume is used for the first BSR; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the present application has the following advantages over conventional schemes:
it can support more diverse service types, such as XR services.
it enhances the flexibility of the terminal.
it can better meet the needs of XR services.
it supports the processing of user-plane data packets with mutual association and/or dependency relation.
it reduces the signaling overhead.
it ensures the services quality and the latency requirements.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of calculating a first data volume in a PDCP, and transmitting a first BSR according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of a protocol structure according to one embodiment of the present application;

FIG. 7 illustrates a schematic diagram of a first PDU set according to one embodiment of the present application;

FIG. 8 illustrates a schematic diagram of a first adjustment amount being used to determine a first data volume according to one embodiment of the present application;

FIG. 9 illustrates a schematic diagram of at least one of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted being used to determine a first adjustment amount according to one embodiment of the present application;

FIG. 10 illustrates a schematic diagram of a first PDU set being used to determine a first adjustment amount according to one embodiment of the present application;

FIG. 11 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of calculating a first data volume in a PDCP, and transmitting a first BSR according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application calculates a first data volume in a PDCP in step 101; transmits a first BSR in step 102;
herein, the first data volume is used for the first BSR; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the first node is a User Equipment (UE).

In one embodiment, the first node is a node in RAN.

In one embodiment, the first node is in RRC_CONNECTED state.

In one embodiment, the first node is in RRC INACTIVE state.

In one embodiment, a MAC of the first node is reset.

In one embodiment, radio link failure is not occurred in the first node.

In one embodiment, handover is not occurred in the first node.

In one embodiment, handover failure is not occurred in the first node.

In one embodiment, RRC re-establishment is not occurred in the first node.

In one embodiment, a Data Radio Bearer (DRB) of the first node is not suspended.

In one embodiment, a first data volume is data volume.

In one embodiment, the first node is not IAB-MT.

In one embodiment, the first node is unrelated to IAB.

In one embodiment, NR backhaul link refers to a backhaul link between IAB nodes or between an IAB-node and an IAB-donor, and the first node is unrelated to NR backhaul link.

In one embodiment, an IAB-donor is a gNB that provides a network access to a UE through a network of backhaul link and access link.

In one embodiment, an IAB-node is an RAN node supporting to a UE NR access link and to an NR backhaul link of a parent node and a child node.

In one embodiment, the first node is unrelated to both an IAB-dornor and an IAB-node.

In one embodiment, the first node is unrelated to IAB-MT.

In one embodiment, the first node is a user terminal.

In one embodiment, the meaning of the phrase of calculating a first data volume in a PDCP comprises: a calculation of the first data volume is executed in a PDCP layer.

In one embodiment, the meaning of the phrase of calculating a first data volume in a PDCP comprises: a calculation of the first data volume is executed in a PDCP entity.

In one embodiment, the meaning of the phrase of calculating a first data volume in a PDCP comprises: executing a data volume calculation in a PDCP.

In one embodiment, the meaning of the phrase of calculating a first data volume in a PDCP comprises: executing a data volume estimation in a PDCP.

In one embodiment, a PDCP layer of the first node indicates the first data volume to a MAC layer of the first node.

In one embodiment, a PDCP layer of the first node indicates the first data volume to an RLC layer of the first node.

In one embodiment, the first BSR is a BSR.

In one embodiment, the first BSR is generated at a MAC layer of the first node.

In one embodiment, the first BSR is a MAC-layer signaling.

In one embodiment, the first BSR is a MAC CE.

In one embodiment, the first BSR is transmitted through uplink.

In one embodiment, the first BSR is generated at the MAC layer.

In one embodiment, the first BSR is used to provide information related to an uplink data volume to a serving cell.

In one embodiment, the first BSR is used to provide information related to an expected uplink data volume to a serving cell.

In one embodiment, the first BSR is used to provide information related to a predicted uplink data volume to a serving cell.

In one embodiment, the first BSR is used to provide information related to an estimated uplink data volume to a serving cell.

In one embodiment, the first BSR is used to provide information related to a pre-allocated uplink data volume to a serving cell.

In one embodiment, the first data volume is linearly associated with the first adjustment amount.

In one embodiment, a value of a logical channel identity corresponding to the first buffer status report is a Short Truncated BSR.

In one embodiment, a value of a logical channel identity corresponding to the first buffer status report is a Long Truncated BSR.

In one embodiment, a value of a logical channel identity corresponding to the first buffer status report is a Short BSR.

In one embodiment, a value of a logical channel identity corresponding to the first buffer status report is a Long BSR.

In one embodiment, a value of a logical channel identity corresponding to the first buffer status report is a padding BSR.

In one embodiment, a value of a logical channel identity corresponding to the first buffer status report is a normal BSR.

In one embodiment, an index of a logical channel identity corresponding to the first buffer status report is any integer between 59-62.

In one embodiment, an index of a logical channel identity corresponding to the first buffer status report is any positive integer other than 5962.

In one embodiment, a format adopted by the first BSR is a format in a first format set.

In one embodiment, a first format set comprises a short BSR format, an extended short BSR format, a long BSR format, an extended long BSR format, a short truncated BSR format, a long truncated BSR format, an extended short truncated BSR format, and an extended long truncated BSR format.

In one embodiment, a format adopted by the first BSR does not belong to the first format set.

In one embodiment, a second format set comprises a pre-emptive BSR format and an extended pre-emptive BSR format.

In one embodiment, a format of the first BSR does not belong to the second format set.

In one embodiment, a format of the first BSR is a format in a third format set.

In one embodiment, the third format set comprises a further extended BSR format, a further extended short BSR format, a further extended long BSR format, a further extended short truncated BSR format, a further extended long truncated BSR format, and a further extended pre-emptive BSR format.

In one embodiment, the first BSR comprises a logical channel group identity and a buffer size.

In one embodiment, the first BSR comprises at least one of a logical channel group identity and a corresponding buffer size.

In one embodiment, the first BSR comprises the first adjustment amount.

In one embodiment, a first BSR is used to indicate the first adjustment amount.

In one embodiment, the first BSR comprises a first BSR field and a second BSR field, and the first BSR field indicates a data volume unrelated to the first adjustment amount in the first data volume; the second BSR field indicates the first adjustment amount.

In one embodiment, the first BSR comprises a first BSR field and a second BSR field, and the first BSR field indicates a data volume unrelated to the first adjustment amount in the first data volume; the second BSR field indicates a data volume related to the first adjustment amount.

In one embodiment, a total number of bits occupied by the first BSR field and the second BSR field is 8 bits.

In one embodiment, the first BSR is or is used to indicate a buffer prediction.

In one embodiment, the first BSR is or is used to indicate an expected buffer.

In one embodiment, the first BSR is or is used to indicate an expected estimation.

In one embodiment, the first node transmits a first BSR, the first BSR indicates a data volume in the first data volume unrelated to the first adjustment amount.

In one subembodiment of the embodiment, the first BSR is a BSR MAC CE.

In one subembodiment of the embodiment, a format of the first BSR belongs to the first format set.

In one subembodiment of the embodiment, a format of the first BSR belongs to the second format set.

In one subembodiment of the embodiment, the first BSR and the first buffer status report are multiplexed into a same MAC PDU.

In one embodiment, the meaning of the phrase that the first data volume being used for the first BSR comprises: the first data volume is used to generate the first BSR.

In one embodiment, the meaning of the phrase that the first data volume being used for the first BSR comprises: a data volume related to the first adjustment amount in the first data volume is used to generate the first BSRBSR.

In one embodiment, the meaning of the phrase that the first data volume being used for the first BSR comprises: a first BSR indicates the first data volume.

In one embodiment, the meaning of the phrase that the first data volume being used for the first BSR comprises: the first BSR indicates a data volume related to the first adjustment amount in the first data volume.

In one embodiment, the meaning of the phrase that the first data volume being used for the first BSR comprises: a PDCP indicates the first data volume to a MAC.

In one embodiment, the meaning of the phrase that the first data volume being used for the first BSR comprises: a calculation of the first data volume is for the first BSR.

In one embodiment, the meaning of the phrase that the first data volume being used for the first BSR comprises: a calculation of the first data volume is for reporting a buffer status, and the first buffer status is used for reporting the buffer status.

In one embodiment, the meaning of the phrase that the first data volume being used for the first BSR comprises: the first data volume is related to the first BSR.

In one embodiment, the meaning of the phrase that the first data volume being used for the first BSR comprises: the first BSR is based on the first data volume.

In one embodiment, the meaning of the phrase that the first data volume being used for the first BSR comprises: a field of the first BSR is determined according to the first data volume.

In one subembodiment of the above embodiment, the field of the first BSR is a Buffer Size field.

In one subembodiment of the above embodiment, the field of the first BSR is a field other than Buffer Size.

In one subembodiment of the above embodiment, the field of the first BSR identifies a total volume of available data acquired according to the first data volume.

In one subembodiment of the above embodiment, the field of the first BSR identifies a total volume of expected data acquired according to the first data volume.

In one subembodiment of the above embodiment, the field of the first BSR identifies a data volume determined according to the first adjustment amount acquired according to the first data volume.

In one subembodiment of the above embodiment, the field of the first BSR comprises 8 bits.

In one subembodiment of the above embodiment, the field of the first BSR comprises 5 bits.

In one subembodiment of the above embodiment, the field of the first BSR comprises 3 bits.

In one subembodiment of the above embodiment, a data volume indicated by the first BSR is measured by byte.

In one embodiment, a size of an RLC header in the MAC sub-header is not considered in the first BSR.

In one embodiment, the first BSR does not comprise expected data of the MAC layer of the first node.

In one embodiment, the first BSR comprises currently available data.

In one embodiment, a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted are for a PDCP entity of the first node or a PDCP transmission entity.

In one embodiment, any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is currently available data.

In one embodiment, a codepoint of an eLCID corresponding to the first BSR is neither 249 nor 255.

In one embodiment, an index of an eLCID corresponding to the first BSR is neither 313 nor 319.

In one embodiment, a codepoint of an eLCID corresponding to the first BSR is an integer in 0227.

In one embodiment, an index of an eLCID corresponding to the first BSR is an integer in 64291.

In one embodiment, a PDCP SDU not constructed with a corresponding PDCP data PDU is or comprises a PDCP SDU not submitted to a layer below the PDCP layer.

In one embodiment, a PDCP SDU not constructed with a corresponding PDCP data PDU is or comprises data that has already arrived at the PDCP layer.

In one embodiment, a PDCP SDU not constructed with a corresponding PDCP data PDU is or comprises a PDCP SDU without a corresponding PDCP PDU.

In one embodiment, a PDCP SDU not constructed with a corresponding PDCP data PDU is or comprises a PDCP SDU that has not yet been encapsulated in a PDCP PDU.

In one embodiment, a PDCP data PDU not submitted to the lower layer is a PDCP data PDU.

In one embodiment, a PDCP data PDU not submitted to the lower layer has already been generated, but has not yet been submitted to a PDCP data PDU of the lower layer.

In one subembodiment of the above embodiment, the lower layer comprises an RLC layer.

In one embodiment, a PDCP control PDU is a PDCP ControlPDU.

In one embodiment, a PDU of a PDCP is either a data PDU or a control PDU.

In one embodiment, a PDCP control PDU is generated at a PDCP.

In one embodiment, an AM DRB is a data radio bearer that uses RLC Acknowledged Mode (AM).

In one embodiment, each PDCP entity is associated with a radio bearer (RB).

In one embodiment, a radio bearer comprises a DRB, a Signaling Radio Bearer (SRB), and a MBS Radio Bearer (MRB).

In one embodiment, a PDCP SDU of an AM DRB that will be retransmitted is a PDCP SDU of an AM DRB that will be retransmitted.

In one embodiment, a PDCP data PDU of an AM DRB that will be retransmitted is a PDCP data PDU of an AM DRB that will be retransmitted.

In one embodiment, the meaning of the phrase that any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included into only former of the first data volume and a first adjustment amount comprises: any of a PDCP SDU not constructed with a corresponding PDCP data PDU, a PDCP data PDU not submitted to a lower layer, a PDCP control PDU, a PDCP SDU of an AM DRB that will be retransmitted, and any type of PDCP SDU or PDCP PDU in a PDCP data PDU of an AM DRB that will be retransmitted is considered by the first data volume while not considered by the first adjustment amount.

In one embodiment, the meaning of the phrase that any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included into only former of the first data volume and a first adjustment amount comprises: any data unit of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is considered by the first data volume while not considered by the first adjustment amount.

In one embodiment, the meaning of the phrase that any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included into only former of the first data volume and a first adjustment amount comprises: a calculation of the first data volume considers or comprises any of a PDCP SDU not constructed with a corresponding PDCP data PDU, a PDCP data PDU not submitted to a lower layer, a PDCP control PDU, a PDCP SDU of an AM DRB that will be retransmitted and a PDCP data PDU of an AM DRB that will be retransmitted.

In one embodiment, the meaning of the phrase that any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included into only former of the first data volume and a first adjustment amount comprises: the first adjustment is unrelated to any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted are all available data.

In one embodiment, a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted are all data arriving at a PDCP or buffered in a PDCP.

In one embodiment, the meaning of the phrase of calculating a first data volume in a PDCP comprises: a calculation of the first data volume is executed in a first PDCP entity.

In one embodiment, a determination of the first adjustment is executed in a second PDCP entity.

In one embodiment, the first PDCP entity is different from the second PDCP entity.

In one embodiment, the first PDCP entity and the second PDCP entity correspond to different DRBs.

In one embodiment, a data volume indicated by the first adjustment amount is not 0.

In one embodiment, a data volume determined by the first adjustment amount is not 0.

In one embodiment, the first data volume is not 0.

In one embodiment, data volumes of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted are not 0.

In one embodiment, a second data volume needs to consider a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted, the second data volume is not 0, and the first data volume comprises the second data volume.

In one embodiment, the first adjustment amount is unrelated to both a PDCP SDU and a PDCP PDU in buffer.

In one embodiment, the PDCP SDU and the PDCP PDU in the buffer comprise a PDCP SDU and a PDCP PDU buffered in the PDCP layer.

In one embodiment, a PDCP SDU and a PDCP PDU in the buffer comprise a PDCP SDU and a PDCP PDU buffered in the protocol layer below the PDCP layer.

In one embodiment, a PDCP entity that executes a calculation of the first data volume is a PDCP entity of a transmitting end.

In one embodiment, if a PDCP entity at the transmitting end is associated with at least 2 RLC entities, and a PDCP replication is activated, the PDCP indicates the first adjustment amount to a MAC entity associated with all associated RLC entities.

In one embodiment, if a PDCP entity at the transmitting end is associated with at least 2 RLC entities, and a PDCP replication is activated, then a PDCP indicates a data volume in the first data volume determined by the first adjustment amount to MAC entities associated with all associated RLC entities.

In one embodiment, if a PDCP entity at the transmitting end is associated with at least 2 RLC entities, and a PDCP replication is activated, then a PDCP indicates to MAC entities associated with all associated RLC entities a data volume in the first data volume not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, all RLC entities associated with a PDCP entity at the transmitting end are activated.

In one embodiment, if a PDCP entity at the transmitting end is associated with at least 2 RLC entities, and a PDCP replication is activated, then a PDCP only indicates the first adjustment amount to a MAC entity associated with an associated RLC entity.

In one embodiment, if a PDCP entity at the transmitting end is associated with at least 2 RLC entities, and a PDCP replication is activated, then a PDCP only indicates a data volume in the first data volume determined by the first adjustment amount to a MAC entity associated with an associated RLC entity.

In one embodiment, if a PDCP entity at the transmitting end is associated with at least 2 RLC entities, and a PDCP replication is activated, then a PDCP only indicates to a MAC entity associated with one associated RLC entity a data volume in the first data volume not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, if a PDCP entity at the transmitting end is associated with at least 2 RLC entities, and a PDCP replication is not activated, then a PDCP only indicates the first adjustment amount to a MAC entity associated with one associated RLC entity.

In one embodiment, if a PDCP entity at the transmitting end is associated with at least 2 RLC entities, and a PDCP replication is not activated, then a PDCP only indicates a data volume in the first data volume determined by the first adjustment amount to a MAC entity associated with one associated RLC entity.

In one embodiment, if a PDCP entity at the transmitting end is associated with at least 2 RLC entities, and a PDCP replication is activated, then a PDCP only indicates to a MAC entity associated with one associated RLC entity a data volume in the first data volume not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, what is included in the first adjustment amount comprises higher-layer data not arriving at a PDCP.

In one embodiment, a data packet included in the first adjustment amount comprises higher-layer data not arriving at a PDCP.

In one embodiment, a data volume included in the first adjustment amount comprises a data volume of higher-layer data not arriving at a PDCP.

In one embodiment, a PDU included in the first adjustment amount comprises higher-layer data not arriving at a PDCP.

In one embodiment, what is included in the first adjustment is higher-layer data not arriving at a PDCP.

In one embodiment, the phrase of not arriving at a PDCP is higher-layer data not submitted to a PDCP.

In one embodiment, the phrase of not arriving at a PDCP is higher-layer data already generated and not submitted to a PDCP.

In one embodiment, the phrase of not arriving at a PDCP comprises IP data.

In one embodiment, the phrase of not arriving at a PDCP comprises not generated data.

In one embodiment, the phrase of not arriving at a PDCP comprises predicted data.

In one embodiment, the phrase of not arriving at a PDCP is estimated data.

In one embodiment, the phrase of not arriving at a PDCP is expected data.

In one embodiment, a first PDCP data unit is a latest PDCP data unit, a sequence number of the first PDCP data unit is a first sequence number, the first adjustment amount comprises a data volume of K PDCP data unit(s) after the first sequence number, where K is a positive integer, and a value of K is related to a value of the first sequence number, when a value of the first sequence number increases, a value of K decreases.

In one subembodiment of the above embodiment, the first PDCP data unit is a PDCP PDU.

In one subembodiment of the above embodiment, the first PDCP data unit is a PDCP SDU.

In one subembodiment of the above embodiment, the first sequence number of the first PDCP data unit is a sequence number of a PDCP PDU.

In one subembodiment of the above embodiment, the first sequence number of the first PDCP data unit is an SN of a PDCP PDU.

In one subembodiment of the above embodiment, the first sequence number is a COUNT value of the first PDCP data unit.

In one subembodiment of the above embodiment, the latest PDCP data unit is data arrives at last.

In one subembodiment of the above embodiment, the latest PDCP data unit is data with a latest allocated sequence number.

In one subembodiment of the above embodiment, the latest PDCP data unit is data with a maximum sequence number.

In one subembodiment of the above embodiment, the latest PDCP data unit is data with a maximum COUNT value.

In one subembodiment of the above embodiment, a modulo value of a sum of a value of the first sequence number and K for a first value is a constant.

In one subembodiment of the above embodiment, the first value is fixed.

In one subembodiment of the above embodiment, the first value is indicated by the network.

In one subembodiment of the above embodiment, the first value is related to service.

In one subembodiment of the above embodiment, a modulo value of a sum of a value of the first sequence number and K for a first value is a first value, and a serving cell of the first node indicates the first value.

In one subembodiment of the above embodiment, a modulo value of a sum of a value of the first sequence number and K for a first value is a first value, and the first QoS information is used to determine the first value.

In one subembodiment of the above embodiment, the first value is for a first service.

In one subembodiment of the above embodiment, the core network indicates the first value.

In one subembodiment of the above embodiment, the first value is a size of a PDU set.

In one embodiment, a protocol layer above a PDCP of the first node indicates a first PDU set, and the first PDU set is used to determine the first adjustment amount; the first PDU set comprises at least one PDU unrelated to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted; the meaning of the phrase that a protocol layer above a PDCP of the first node indicates a first PDU set comprises: a protocol layer above a PDCP of the first node indicates a number of PDU(s) comprised in the first PDU set, or a protocol layer above a PDCP of the first node indicates a data volume of the first PDU set.

In one subembodiment of the above embodiment, the protocol layer above a PDCP of the first node is NAS.

In one subembodiment of the above embodiment, the protocol layer above a PDCP of the first node is an application layer.

In one subembodiment of the above embodiment, the first QoS information is used to determine the first PDU set.

In one subembodiment of the above embodiment, the first QoS information is used to indicate the first PDU set.

In one subembodiment of the above embodiment, the first PDU set comprises PDUs with interdependent relations.

In one subembodiment of the above embodiment, the first PDU set comprises PDUs that need to be processed together.

In one subembodiment of the above embodiment, the first PDU set comprises PDUs that have dependent relations on same data.

In one subembodiment of the above embodiment, the first PDU set comprises data that needs to be processed before a specific time.

In one subembodiment of the above embodiment, the first PDU set comprises a PDU PDU.

In one subembodiment of the above embodiment, the first PDU set comprises a PDU SDU.

In one subembodiment of the above embodiment, the first PDU set comprises a PDU of a protocol layer above a PDCP layer.

In one subembodiment of the above embodiment, the first PDU set comprises an IP PDU.

In one subembodiment of the above embodiment, the first PDU set comprises data of a flow.

In one subembodiment of the above embodiment, the at least one PDU comprised in the first PDU set unrelated to a PDCP SDU not constructed with a corresponding PDCP data PDU, a PDCP data PDU not submitted the lower layer, a PDCP control PDU, a PDCP SDU of an AM DRB that will be retransmitted and a PDCP data PDU of an AM DRB that will be retransmitted is used to trigger the behavior of calculating a first data volume in a PDCP.

In one subembodiment of the above embodiment, the at least one PDU comprised in the first PDU set belonging to a PDCP SDU not constructed with a corresponding PDCP data PDU, a PDCP data PDU not submitted the lower layer, a PDCP control PDU, a PDCP SDU of an AM DRB that will be retransmitted and a PDCP data PDU of an AM DRB that will be retransmitted is used to trigger the behavior of calculating a first data volume in a PDCP, or is used to trigger reporting the first data volume to a MAC entity.

In one subembodiment of the above embodiment, the at least one PDU comprised in the first PDU set unrelated to a PDCP SDU not constructed with a corresponding PDCP data PDU, a PDCP data PDU not submitted the lower layer, a PDCP control PDU, a PDCP SDU of an AM DRB that will be retransmitted and a PDCP data PDU of an AM DRB that will be retransmitted is a first one of PDUs in the first PDU set.

In one subembodiment of the above embodiment, a PDU comprised in the first PDU set belonging to a PDCP SDU not constructed with a corresponding PDCP data PDU, a PDCP data PDU not submitted the lower layer, a PDCP control PDU, a PDCP SDU of an AM DRB that will be retransmitted and a PDCP data PDU of an AM DRB that will be retransmitted is a first one of PDUs in the first PDU set.

In one subembodiment of the above embodiment, an earliest PDU in the first PDU set belongs to one of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one subembodiment of the above embodiment, the at least one PDU comprised in the first PDU set unrelated to a PDCP SDU not constructed with a corresponding PDCP data PDU, a PDCP data PDU not submitted a lower layer, a PDCP control PDU, a PDCP SDU of an AM DRB that will be retransmitted and a PDCP data PDU of an AM DRB that will be retransmitted does not depend on a PDU of other PDU decodings in the first PDU set.

In one subembodiment of the above embodiment, the at least one PDU in the first PDU set unrelated to a PDCP SDU not constructed with a corresponding PDCP data PDU, a PDCP data PDU not submitted the lower layer, a PDCP control PDU, a PDCP SDU of an AM DRB that will be retransmitted, a PDCP data PDU of an AM DRB that will be retransmitted depends on other PDU decodings in the first PDU set.

In one embodiment, the earliest PDU in the first PDU set is a PDU arrives firstly.

In one embodiment, the earliest PDU in the first PDU set is a PDU with a smallest number.

In one embodiment, the earliest PDU in the first PDU set is a PDU with a smallest sequence number.

In one embodiment, decoding in the present application comprises decoding of the application layer.

In one embodiment, decoding in the present application comprises cell decoding.

In one embodiment, a data volume of the first PDU set comprises a number of byte(s) comprised in the first PDU set.

In one embodiment, a data volume of the first PDU set comprises a PDCP SDU not constructed with a corresponding PDCP data PDU, a PDCP data PDU not submitted the lower layer, a PDCP control PDU, a PDCP SDU of an AM DRB that will be retransmitted and a PDCP data PDU of an AM DRB that will be retransmitted as well as a number of comprised byte(s) in the first PDU set.

In one embodiment, a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted are for a same PDCP entity.

In one embodiment, the first data volume comprises a data volume of multiple PDCP entities.

### Embodiment 2

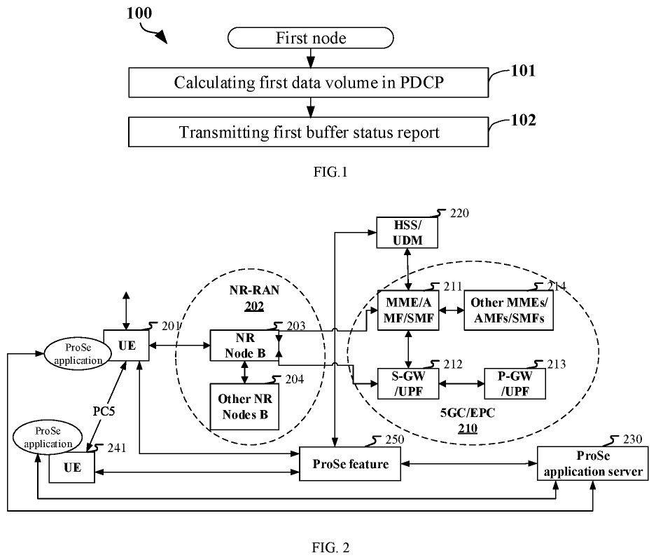

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the first node in the present application is a gNB 203.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE 201 comprises a mobile phone.

In one embodiment, the UE 201 is a vehicle comprising a car.

In one embodiment, the UE 201 supports sidelink communications.

In one embodiment, the UE 201 supports MBS transmission.

In one embodiment, the UE 201 supports MBMS transmission.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

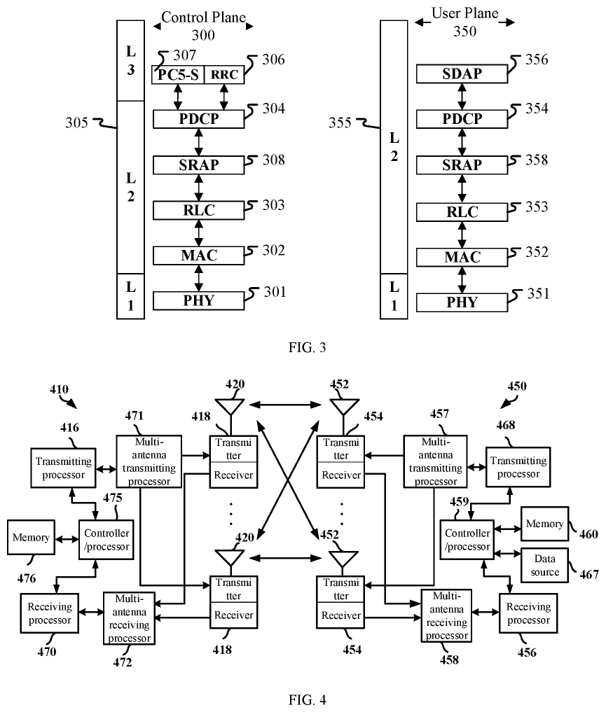

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay service, its control plane can also comprise PC5-S307, the adaptation sub-layer Sidelink Relay Adaptation Protocol (SRAP) 308, and its user plane can also comprise the adaptation sub-layer SRAP 358, the introduction of the adaptation layer helps lower layers, such as MAC layer, RLC layer, to multiplex and/or distinguish data from multiple source UEs. For nodes that do not involve relay communications, PC5-S307, SRAP 308 and SRAP 358 are not required in the communication process.

The user plane in the present application refers to the user plane 350 in FIG. 3.

In one embodiment, the radio protocol architecture in FIG. 3 is applicable to the first node in the present application.

In one embodiment, the first BSR in the present application is generated by the MAC 302.

In one embodiment, the first signaling in the present application is generated by the MAC 302, the RRC 306, or the NAS layer.

In one embodiment, the first QoS information in the present application is generated by the RRC 306 or the NAS layer.

In one embodiment, the first scheduling information in the present application is generated by the PHY 301. In one embodiment, the first PDCP PDU set in the present application is generated by the PDCP 354.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: calculates a first data volume in a PDCP; transmits a first buffer status report; herein, the first data volume is used for the first buffer status report; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the first communication device 450 comprises at least one processor and at least one memory. a memory that stores a computer readable instruction program. The computer readable instruction program generates an action when executed by at least one processor. The action includes: calculating a first data volume in a PDCP; transmitting a first buffer status report; herein, the first data volume is used for the first buffer status report; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the first communication device 450 corresponds to a first node in the present application.

In one embodiment, the first communication device 450 is a UE.

In one embodiment, the first communication device 450 is a vehicle terminal.

In one embodiment, the first communication device 450 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the first QoS information in the present application.

In one embodiment, the receiver 454 (comprising the antenna 452), the receiving processor 456 and the controller/processor 459 are used to receive the first scheduling information in the present application.

In one embodiment, the transmitter 454 (comprising antenna 452), the transmitting processor 468 and the controller/processor 459 are used to transmit the first PDCP PDU set in the present application.

In one embodiment, the transmitter 454 (comprising antenna 452), the transmitting processor 468 and the controller/processor 459 are used to transmit the first BSR in the present application.

### Embodiment 5

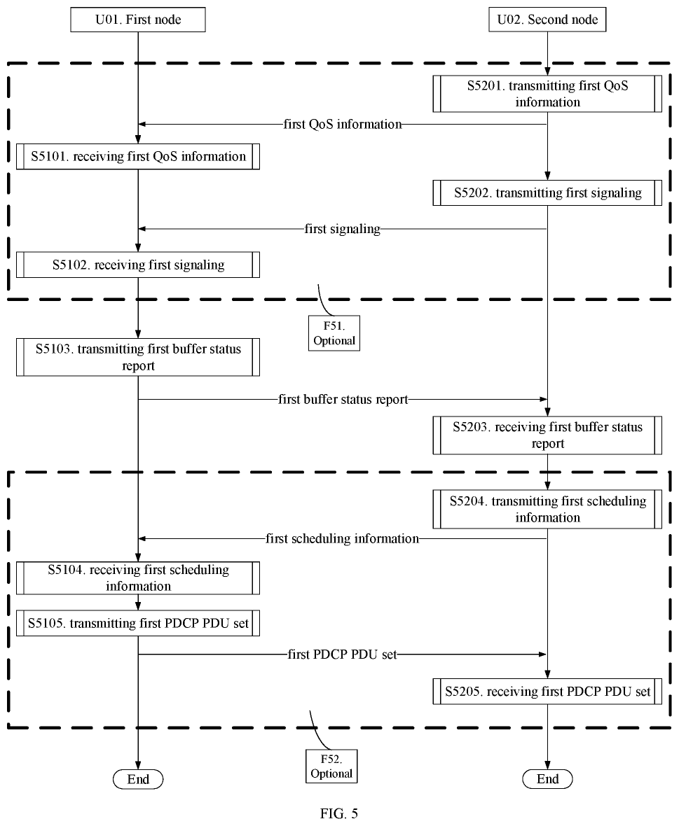

Embodiment 5 illustrates a flowchart of radio signal transmission according to one embodiment in the present application, as shown in FIG. 5. In FIG. 5, U01 corresponds to the first node of the present application; it is particularly underlined that the order illustrated in the embodiment does not put constraints over sequences of signal transmissions and implementations and steps in F51 and F52 are optional.

The first node U01 receives first QoS information in step S5101; receives a first signaling in step S5102; transmits a first buffer status report in step S5103; receives first scheduling information in step S5104; transmits a first PDCP PDU set in step S5105.

The second node U02 transmits first QoS information in step S5201; transmits a first signaling in step S5202; receives a first BSR in step S5203; transmits first scheduling information in step S5204; receives a first PDCP PDU set in step S5205.

In embodiment 5, the first node U01 calculates a first data volume in a PDCP; the first data volume is used for the first BSR; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the first node U01 is a UE, and the second node U02 is a serving cell or a cell group of the first node U01.

In one subembodiment of the embodiment, the first data packet is transmitted by using uplink resources or links.

In one embodiment, the first node U01 is a UE, and the second node U02 is a base station serving the first node U01.

In one subembodiment of the embodiment, the first data packet is transmitted by using uplink resources or links.

In one embodiment, the first data packet is transmitted by using sidelink.

In one embodiment, both the first node U01 and the second node U02 are UEs.

In one embodiment, the first node U01 is a node in RAN.

In one embodiment, the second node U02 is a UE.

In one embodiment, the first node U01 transmits the first data packet through uplink.

In one embodiment, the first QoS information is transmitted through the NAS layer.

In one embodiment, the first QoS information is information of the NAS layer.

In one embodiment, the first QoS information is transmitted through an RRC message.

In one embodiment, the first QoS information comprises 5QI.

In one embodiment, the first QoS information comprises quality indication.

In one embodiment, the first QoS information comprises QoS characteristics.

In one embodiment, the first QoS information comprises arriving at a time interval.

In one embodiment, the first QoS information comprises a service model or a traffic arrival model.

In one embodiment, the first QoS information comprises time delay requirement.

In one embodiment, the first QoS information comprises packet delay budget (PDB).

In one embodiment, the first QoS information comprises parameters of a PDU set.

In one embodiment, the first QoS information comprises an arrival rate or frame rate.

In one subembodiment of the above embodiment, the arrival rate or frame rate is used to determine the first time length.

In one embodiment, the first QoS information is NAS information.

In one embodiment, the first QoS information is generated by the second node U02.

In one embodiment, the first QoS information is information generated by the NAS layer and forwarded by the second node U02.

In one embodiment, the first QoS information is information generated by the application layer and forwarded by the second node U02.

In one embodiment, the first QoS information triggers the first message.

In one embodiment, the first QoS information is received before the first message.

In one embodiment, first QoS information is used to indicate at least one of a first time interval, a second time interval or a first time length.

In one embodiment, the first QoS information comprises a first QoS parameter, and the first QoS parameter comprised in first QoS information has a mapping relation with a set of QoS characteristics.

In one subembodiment of the above embodiment, the first QoS parameter comprised in the first QoS information comprises 5QI.

In one embodiment, the set of QoS characteristics comprises resource type, default priority, PDB, error packet rate, default maximum data burst volume and default averaging window; a type of resource comprises Guaranteed Bit Rate (GBR) and Non-GBR; a default priority is identified by an integer, and the smaller the value, the higher the priority.

In one embodiment, the first QoS information comprises a group of QoS characteristics.

In one embodiment, the group of QoS characteristics comprises at least one QoS characteristic.

In one embodiment, the QoS characteristic is a parameter related to QoS.

In one embodiment, the group of QoS characteristics comprises: an interactive delay.

In one embodiment, the group of QoS characteristics comprises: a backhaul interactive delay.

In one embodiment, the group of QoS characteristics comprises: a motion-to-photon delay.

In one embodiment, the group of QoS characteristics comprises: a roundtrip time (RTT).

In one embodiment, the group of QoS characteristics comprises: a roundtrip delay.

In one embodiment, the group of QoS characteristics comprises: a maximum RTT.

In one embodiment, the group of QoS characteristics comprises: a pose-to-photon delay.

In one embodiment, the group of QoS characteristics comprises: a pose-to-render-to-photon time.

In one embodiment, the group of QoS characteristics comprises: a backhaul delay of XR service.

In one embodiment, the group of QoS characteristics comprises: an RTT of XR service.

In one embodiment, the group of QoS characteristics comprises: a delay interval.

In one embodiment, the group of QoS characteristics comprises: an interactive delay interval.

In one embodiment, the group of QoS characteristics comprises: a minimum interactive delay.

In one embodiment, the group of QoS characteristics comprises: a maximum interactive delay.

In one embodiment, the group of QoS characteristics comprises: a minimum RTT.

In one embodiment, the group of QoS characteristics comprises: a maximum RTT.

In one embodiment, the group of QoS characteristics comprises: a minimum XR delay.

In one embodiment, the group of QoS characteristics comprises: a maximum XR delay.

In one embodiment, parameters related to time delay comprised in the group of QoS characteristics is an average value.

In one embodiment, parameters related to time delay comprised in the group of QoS characteristics is a minimum value.

In one embodiment, parameters related to time delay comprised in the group of QoS characteristics is a maximum value.

In one embodiment, the group of QoS characteristics comprises: service structure.

In one embodiment, the group of QoS characteristics comprises: service model or service template.

In one embodiment, the group of QoS characteristics comprises: an uplink PDB and a downlink PDB.

In one subembodiment of the embodiment, a sum of an uplink PDB and a downlink PDB is an interactive backhaul delay.

In one embodiment, the group of QoS characteristics comprises: a pose-to-response time interval or time delay.

In one embodiment, the group of QoS characteristics comprises: a delay requirement.

In one embodiment, the group of QoS characteristics comprises: a delay jitter.

In one embodiment, the group of QoS characteristics comprises: response time.

In one embodiment, parameter related to a time delay comprised in the first QoS information is the first time offset.

In one embodiment, a parameter related to an interactive time delay comprised in the first QoS information is the first time offset.

In one embodiment, a parameter related to an RTT comprised in the first QoS information is the first time offset.

In one embodiment, a parameter related to a time delay comprised in the first QoS information is approximated or rounded to a specific value to be equal to the first time offset.

In one embodiment, a parameter related to an interactive delay comprised in the first QoS information are approximated or rounded to a specific value to be equal to the first time offset.

In one embodiment, a parameter related to an RTT comprised in the first QoS information are approximated or rounded to a specific value to be equal to the first time offset.

In one embodiment, a time-related parameter comprised in the group of QoSs is the first time interval.

In one embodiment, a group of time-related parameters comprised in the group of QoSs is the first time interval and the second time interval.

In one embodiment, a delay-related parameter comprised in the group of QoSs is the first time interval.

In one embodiment, a group of delay-related parameters comprised in the group of QoSs is the first time interval and the second time interval.

In one embodiment, an arrival time-related parameter comprised in the group of QoSs is the first time interval.

In one embodiment, a set of arrival time-related parameters comprised in the group of QoSs is the first time interval and the second time interval.

In one embodiment, a parameter related to an offset comprised in the group of QoSs is used to determine the second time interval.

In one embodiment, a parameter related to an offset comprised in the group of QoSs is used to determine the first offset set.

In one embodiment, a parameter related to time or period comprised in the group of QoSs is used to determine the first time length.

In one embodiment, a parameter related to packet rate or period comprised in the group of QoSs is the first time length.

In one embodiment, a DRX-related parameter comprised in the group of QoSs indicates the first time interval.

In one embodiment, a DRX-related parameter comprised in the group of QoSs indicates the second time interval.

In one embodiment, a DRX-related parameter comprised in the group of QoSs indicates the first time length.

In one embodiment, the group of QoSs comprises at least one offset in the first offset set.

In one embodiment, the first QoS information comprises a dependency relation of service data.

In one embodiment, the first QoS information comprises a time relation of service data.

In one embodiment, the first QoS information comprises an arrival time or a model of the arrival time of service data.

In one embodiment, the first QoS information indicates grouping characteristics of service data.

In one embodiment, the first QoS information indicates that service data is divided into multiple groups.

In one embodiment, the first QoS information indicates that service data is divided into multiple PDU sets.

In one embodiment, the first QoS information is for interactive services.

In one embodiment, the first QoS information is used to determine a first transmission time.

In one embodiment, the first QoS information indicates a first transmission time set, and the first transmission time is a transmission time in the first transmission time set.

In one subembodiment of the embodiment, the first transmission time is a next transmission time in the first transmission time set.

In one subembodiment of the embodiment, the first transmission time is a next closest transmission time in the first transmission time set.

In one subembodiment of the embodiment, service targeted by the first QoS information is periodic, and a transmission time in the first transmission time set is a time of periodic transmission.

In one subembodiment of the embodiment, the first QoS information indicates a first transmission interval, and the first transmission time is a time determined by a first transmission interval after a previous transmission.

In one embodiment, the first adjustment amount comprises an expected data volume of a PDCP data unit before the first transmission time.

In one subembodiment of the embodiment, the first QoS information indicates an expected data volume of a PDCP data unit before the first transmission time.

In one subembodiment of the embodiment, the first node determines a data volume of the expected PDCP data unit before the first transmission time based on an internal algorithm.

In one subembodiment of the embodiment, the first node determines or estimates the expected data volume of a PDCP data unit before the first transmission time based on a data unit buffered in the PDCP layer.

In one subembodiment of the embodiment, service model indicated by the first QoS information is used to determine or estimate a data volume of the expected PDCP data unit before the first transmission time.

In one subembodiment of the embodiment, the expected data volume of a PDCP data unit is an expected data volume of higher-layer data.

In one subembodiment of the embodiment, the expected data volume of a PDCP data unit is an estimated data volume of higher-layer data.

In one embodiment, the first transmission time is related to a next running of an onduration timer of a DRX.

In one embodiment, an onduration timer of the DRX is for the first node.

In one embodiment, an onduration timer of the DRX corresponds to a long DRX.

In one embodiment, an onduration timer of the DRX corresponds to a short DRX.

In one embodiment, the first transmission time is a start time of a next running of an onduration timer of a DRX.

In one embodiment, the first transmission time is an expiration time of a next running of an onduration timer of a DRX.

In one embodiment, an expiration value of an onduration timer of a DRX is network-configured.

In one embodiment, an onduration timer of a DRX runs periodically.

In one embodiment, the first signaling comprises a message of NAS.

In one embodiment, the first signaling comprises an RRC message.

In one embodiment, the first signaling comprises an RRCReconfiguration message.

In one embodiment, the first signaling comprises a cell used for configuring a session.

In one embodiment, the first signaling comprises a cell used for configuring a flow.

In one embodiment, the first signaling comprises a cell used for configuring a PDCP.

In one embodiment, the first signaling comprises a cell used for configuring a radio bearer.

In one embodiment, the first signaling indicates a first sequence number threshold.

In one embodiment, a first PDCP data unit is a last PDCP data unit to be allocated a sequence number, a sequence number of the first PDCP data unit is a first sequence number, and the first adjustment amount comprises a data volume of a PDCP data unit not exceeding the first sequence number threshold after the first sequence number.

In one subembodiment of the above embodiment, the first adjustment amount comprises a data volume of a PDCP data unit after the first sequence number and up to the first sequence number threshold.

In one subembodiment of the above embodiment, the first PDCP data unit is or comprises a PDCP SDU.

In one subembodiment of the above embodiment, the first PDCP data unit is or comprises a PDCP PDU.

In one subembodiment of the above embodiment, the first adjustment amount comprises that the PDCP data unit not exceeding the first sequence number threshold after the first sequence number comprises a PDCP SDU.

In one subembodiment of the above embodiment, the first adjustment amount comprises that the PDCP data unit not exceeding the first sequence number threshold after the first sequence number comprises a PDCP PDU.

In one subembodiment of the above embodiment, the phrase of a latest allocated sequence number refers an SN number for allocating a PDCP PDU.

In one subembodiment of the above embodiment, the phrase of a latest allocated sequence number refers allocating a COUNT.

In one subembodiment of the above embodiment, the meaning of the phrase that a first PDCP data unit is a PDCP data unit of a latest allocated sequence number is: the first PDCP data unit is latest data to arrive at a PDCP.

In one subembodiment of the above embodiment, the meaning of the phrase that a first PDCP data unit is a PDCP data unit of a latest allocated sequence number is: the first PDCP data unit is latest data that arrives at a PDCP from a higher layer.

In one subembodiment of the above embodiment, the first sequence number is an SN of a PDCP.

In one subembodiment of the above embodiment, the first sequence number is a COUNT of a PDCP.

In one subembodiment of the above embodiment, the first node determines a data volume of a PDCP data unit after the first sequence number and not exceeding the first sequence number threshold based on the first QoS information.

In one subembodiment of the above embodiment, the first node determines a data volume of a PDCP data unit after the first sequence number not exceeding the first sequence number threshold based on the network indication.

In one subembodiment of the above embodiment, the first node determines a data volume of a PDCP data unit after the first sequence number not exceeding the first sequence number threshold based on the internal algorithm.

In one embodiment, the first sequence number threshold is a positive integer.

In one embodiment, the first signaling indicates a first data volume threshold; the first adjustment amount comprises a data volume not exceeding the first data volume threshold.

In one subembodiment of the embodiment, the first data volume threshold is measured by byte.

In one subembodiment of the embodiment, the first data volume threshold is measured by bit.

In one subembodiment of the embodiment, the first data volume threshold is measured by n bytes, where n is an integer greater than 1.

In one subembodiment of the embodiment, the first signaling indicates an index of the first data volume threshold.

In one subembodiment of the above embodiment, an index of the first data volume threshold and the first data volume threshold have a mapping relation.

In one subembodiment of the above embodiment, the first node determines the first adjustment amount according to the first QoS information.

In one subembodiment of the above embodiment, the first node determines the first adjustment amount according to the network indication.

In one subembodiment of the above embodiment, the first node determines the first adjustment amount according to the internal algorithm.

In one subembodiment of the above embodiment, the meaning of the phrase that the first adjustment amount comprises a data volume not exceeding the first data volume threshold is: the first adjustment amount does not exceed the first data volume threshold.

In one embodiment, the first scheduling information is transmitted through an RRC message.

In one embodiment, the first scheduling information comprises a configured grant.

In one embodiment, the first scheduling information comprises a physical-layer signal.

In one embodiment, the first scheduling information comprises downlink control information (DCI).

In one embodiment, the first scheduling information indicates time-frequency resources.

In one embodiment, a data volume comprised in the first PDCP PDUC set is included in the first data volume.

In one embodiment, a data volume comprised in the first PDCP PDUC set is included in the first adjustment amount.

In one embodiment, any PDCP PDU in the first PDCP PDU set is a data PDU.

In one embodiment, the first field is a PDCP SN field.

In one embodiment, the second field only comprises 1 bit.

In one embodiment, the second field comprises 2 bits.

In one embodiment, assuming that a first adjustment amount is not configured, the second field is an R field.

In one embodiment, the PCU set is the first PDU set.

In one embodiment, the PDU set is generated by the first PDU set.

In one embodiment, any PDU in the PDU set is or comprises a PDCP SDU.

In one embodiment, any PDU in the PDU set is or comprises a PDCP PDU.

In one embodiment, any PDCP PDU in the first PDCP PDU set comprises a first field and a second field, the first field indicates a sequence number of the any PDCP PDU, and the second field indicates whether the any PDCP PDU belongs to a PDU set.

In one embodiment, any PDCP PDU in the first PDCP PDU set comprises the first field and the second field.

In one embodiment, the first PDU set is used to generate the first PDCP PDU set.

In one embodiment, the second field is not a D/C field.

In one embodiment, the second field and the first field occupy a same octet of a PDCP PDU head.

In one embodiment, the second field occupies at least a part of a first octet of a PDCP PDU header.

In one embodiment, a value of the second field is 0 or 1.

In one embodiment, when a value of the second field is reversed, it indicates a next or a new PDU set.

In one embodiment, when a value of the second field is assumed reversed, it indicates a next or a new PDU set.

### Embodiment 6

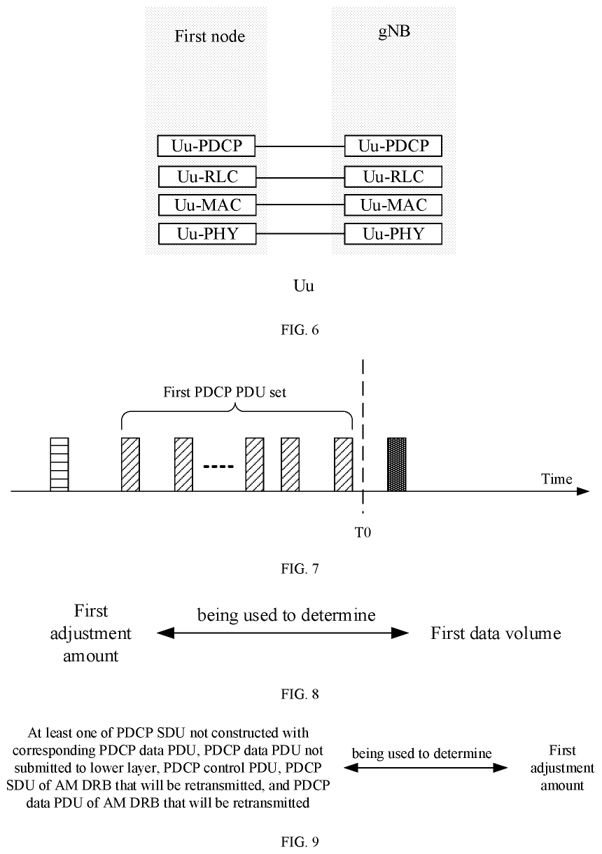

Embodiment 6 illustrates a schematic diagram of a protocol structure according to one embodiment of the present application, as shown in FIG. 6.

Embodiment 6 is based on Embodiment 3 and further illustrates other information related to the present application; where gNB corresponds to the second node in the present application.

FIG. 6 illustrates the protocol stack structure of a Uu interface, in FIG. 6, “Uu-” represents the protocol layer or protocol entity of the Uu interface, for example, Uu-PDCP represents a PDCP of the Uu interface.

In one embodiment, a calculation of the first data volume is at a Uu-PDCP of a first node.

In one embodiment, a determination of the first adjustment is at a Uu-PDCP of a first node.

In one embodiment, the first BSR is generated at a Uu MAC of a first node.

In one embodiment, Uu-PDCP of the first node indicates the first data volume to Uu-MAC.

In one embodiment, Uu-PDCP of a first node indicates the first adjustment amount to Uu-MAC.

In one embodiment, the network indicates which PDCP SDUs of an AM DRB need to be retransmitted.

In one embodiment, the network indicates which PDCP PDUs of an AM DRB need to be retransmitted.

In one embodiment, after receiving an indication from the network, all PDCP SDUs of an AM DRB that have not been confirmed to be transmitted successfully must be retransmitted.

In one embodiment, after receiving an indication from the network, all PDCP PDUs of an AM DRB that have not been confirmed to be transmitted successfully must be retransmitted.

In one embodiment, higher-layer data that has not yet arrived at the PDCP comprises data from an SDAP layer.

In one embodiment, the higher-layer data that has not yet arrived at the PDCP comprises data from a protocol layer above the SDAP layer.

In one embodiment, the first PDCP data unit is received and/or processed by a Uu-PDCP of a first node.

In one embodiment, the first PDCP data unit is buffered in a Uu-PDCP of a first node.

In one embodiment, data included in a first adjustment amount is not buffered in a Uu-PDCP of a first node.

In one embodiment, the first PDU set is a set of PDUs or SDUs of the Uu-PDCP layer.

In one embodiment, the first PDU set is a set of PDUs for a layer above the Uu-PDCP.

### Embodiment 7

Embodiment 7 illustrates a schematic diagram of a first PDU set according to one embodiment of the present application, as shown in FIG. 7.

In one embodiment, the first PDU set comprises at least two PDUs.

In one embodiment, the first PDU set comprises a limited number of PDU(s).

In one embodiment, a PDU comprised in the first PDU set is an IP packet.

In one embodiment, a PDU comprised in the first PDU set is data of XR service.

In one embodiment, the first PDU set comprises service data corresponding to a same PDU session.

In one embodiment, a number of PDU(s) comprised in the first PDU set is 1.

In one embodiment, a number of PDUs comprised in the first PDU set is 2.

In one embodiment, PDUs comprised in the first PDU set are more than 2.

In one embodiment, PDUs comprised in the first PDU set are not greater than 1024.

In one embodiment, PDUs comprised in the first PDU set are not greater than 65.

In one embodiment, PDUs in the first PDU set arrive sequentially in time domain.

In one embodiment, arrival time of PDUs in the first PDU set in time domain are non-overlapping.

In one embodiment, time at which PDUs in the first PDU set are transmitted in time domain is not overlapping.

In one embodiment, time at which PDUs in the first PDU set are transmitted in time domain is overlapping.

In one embodiment, PDUs in the first PDU set are transmitted sequentially in time domain.

In one embodiment, PDUs in the first PDU set are transmitted at the same time in time domain.

In one embodiment, PDUs in the first PDU set arrive within a first time window.

In one subembodiment of the embodiment, the first time window is pre-defined.

In one subembodiment of the embodiment, the first time window is configured by a signaling.

In one subembodiment of the above embodiment, the first time window is self-configured by the first node.

In one subembodiment of the above embodiment, the first time window is determined by a QoS parameter of the first PDU set.

In one subembodiment of the above embodiment, the first QoS information comprises a QoS parameter of the first PDU set.

In one subembodiment of the above embodiment, the first time window is determined by a QoS characteristic of the first PDU set.

In one subembodiment of the above embodiment, an end time of the first time window is the first transmission time.

In one subembodiment of the above embodiment, the first PDU set carries information of the first time window.

In one subembodiment of the above embodiment, a PDU in the first PDU set carries information of the first time window.

In one subembodiment of the embodiment, the first information indicates the first time window.

In one embodiment, a PDU in the first PDU set is transmitted before a first transmission time.

In one embodiment, in FIG. 7, TO is a latest allowed processed time for any PDU in the first PDU set.

In one embodiment, in FIG. 7, TO is a latest allowed transmitted time for any PDU in the first PDU set.

In one embodiment, in FIG. 7, TO is a latest allowed time received by the application layer for any PDU in the first PDU set.

In one embodiment, in FIG. 7, TO is a latest allowed processed time for the first PDU set.

In one embodiment, in FIG. 7, TO is a latest allowed transmitted time for the first PDU set.

In one embodiment, in FIG. 7, TO is a latest allowed time received by the application layer for the first PDU set.

In one embodiment, QoS information of the first PDU set comprises the TO time.

In one embodiment, QoS information of any PDU of the first PDU set comprises the TO time.

In one embodiment, QoS information of any PDU of the first PDU set can determine the TO time.

In one embodiment, in the first PDU set, a PDU that cannot be processed before TO is dropped.

In one embodiment, delay requirement indicated by the QoS information of the first PDU set comprises TO time.

In one embodiment, delay requirement indicated by the QoS information of the second PDU comprises TO time.

In one embodiment, the first transmission time is TO time.

### Embodiment 8

Embodiment 8 illustrates a schematic diagram of a first adjustment amount being used to determine a first data volume according to one embodiment of the present application, as shown in FIG. 8.

In one embodiment, the first data volume is linearly associated with the first adjustment amount.

In one embodiment, a data volume in the first data volume unrelated to the first adjustment amount is determined by a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first adjustment amount is equal to a sum of a data volume of a PDCP SDU not constructed with a corresponding PDCP data PDU, a PDCP data PDU not submitted to a lower layer, a PDCP control PDU, a PDCP SDU of an AM DRB that will be retransmitted and a PDCP data PDU of an AM DRB that will be retransmitted plus the first adjustment amount.

In one embodiment, the first adjustment amount comprises an expected data volume of a PDCP layer of the first node.

In one embodiment, the first adjustment amount comprises an estimated data volume of a PDCP layer of the first node.

In one embodiment, the first adjustment amount comprises an expected data volume related to the first PDU set of a PDCP layer of the first node.

In one embodiment, the first adjustment amount comprises a margin of a data volume.

In one embodiment, a PDCP entity of the first node includes the first adjustment amount in the first data volume.

In one embodiment, the meaning of the phrase that a PDCP entity of the first node includes the first adjustment amount in the first data volume comprises: a PDCP entity of the first node considers the first adjustment amount as a PDCP data volume.

In one embodiment, the first data volume is a PDCP data volume.

In one embodiment, the first adjustment amount is for a radio bearer other than a DRB, SRB and an MRB.

In one embodiment, the first adjustment amount is for a first DRB, and the first DRB is configured to use the first adjustment amount.

In one embodiment, data targeted by the first adjustment amount has not yet been constructed as a PDCP SDU.

In one embodiment, data targeted by the first adjustment amount is neither a PDCP SDU nor a PDCP PDU.

In one embodiment, data targeted by the first adjustment amount is about to become a PDCP SDU.

In one embodiment, the first node is not configured with a DAPS.

In one embodiment, the first adjustment amount is non-zero.

In one embodiment, the first data volume is non-zero.

In one embodiment, the first adjustment amount has a constraint relation with the first data volume.

In one embodiment, a maximum value of the first adjustment amount is related to a data volume of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, a maximum value of the first adjustment is unrelated to a data volume of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first adjustment amount is a coefficient.

In one embodiment, a product of the first adjustment amount and a value is used to determine the first data volume.

In one embodiment, the first data volume is related to a data volume of a PDCP SDU not constructed with a corresponding PDCP data PDU, a PDCP data PDU not submitted to a lower layer, a PDCP control PDU, a PDCP SDU of an AM DRB that will be retransmitted and a PDCP data PDU of an AM DRB that will be retransmitted multiplies the first adjustment amount.

In one embodiment, the first data volume is equal to a data volume of a PDCP SDU not constructed with a corresponding PDCP data PDU, a PDCP data PDU not submitted to a lower layer, a PDCP control PDU, a PDCP SDU of an AM DRB that will be retransmitted and a PDCP data PDU of an AM DRB that will be retransmitted multiplies the first adjustment amount.

In one embodiment, the first data volume is equal to a smaller one of a data volume of a PDCP SDU not constructed with a corresponding PDCP data PDU, a PDCP data PDU not submitted to a lower layer, a PDCP control PDU, a PDCP SDU of an AM DRB that will be retransmitted and a PDCP data PDU of an AM DRB that will be retransmitted multiples the first adjustment amount and a specific value.

In one embodiment, the first adjustment amount is not equal to 1.

In one embodiment, the MAC layer of the first node indicates the first adjustment amount to the PDCP

layer of the first node.

In one embodiment, the RLC layer of the first node indicates the first adjustment amount to the PDCP layer of the first node.

In one embodiment, the SDAP layer of the first node indicates the first adjustment amount to the PDCP layer of the first node.

In one embodiment, the NAS layer of the first node indicates the first adjustment amount to the PDCP layer of the first node.

In one embodiment, the MAC layer of the first node indicates first information to the PDCP layer of the first node, and the first information is used to determine the first adjustment amount.

In one embodiment, the RLC layer of the first node indicates second information to the PDCP layer of the first node, and the second information is used to determine the first adjustment amount.

In one embodiment, the first adjustment amount takes into account a header of the protocol.

In one subembodiment of the embodiment, a header of the protocol comprises a header of the PDCP protocol.

In one embodiment, the first adjustment amount does not take into account a header of the protocol.

In one subembodiment of the embodiment, a header of the protocol comprises a header of the PDCP protocol.

### Embodiment 9

Embodiment 9 illustrates a schematic diagram of at least one of a PDCP SDU not constructed with a corresponding PDCP data PDU, a PDCP data PDU not submitted to a lower layer, a PDCP control PDU, a PDCP SDU of an AM DRB that will be retransmitted or a PDCP data PDU of an AM DRB that will be retransmitted being used to determine a first adjustment amount according to one embodiment of the present application, as shown in FIG. 9.

In one embodiment, a first data unit is a PDU SDU not constructed with a corresponding PDCP data PDU, or a first data unit is a PDCP data PDU not submitted to a lower layer, or a first data unit is a PDCP SDU of an AM DRB that will be retransmitted, or a first data unit is a PDCP data PDU of an AM DRB that will be retransmitted.

In one subembodiment of the above embodiment, the first data unit is a PDCP PDU.

In one subembodiment of the above embodiment, the first data unit is a PDCP SDU.

In one subembodiment of the above embodiment, the first data unit uses a first radio bearer, and the first radio bearer is used to carry a first flow.

In one subembodiment of the above embodiment, the first flow is a QoS flow.

In one subembodiment of the above embodiment, the first flow is related to XR service.

In one subembodiment of the above embodiment, the first QoS information is used to indicate QoS information of the first flow.

In one subembodiment of the above embodiment, the first data unit belongs to a first PDU set.

In one subembodiment of the above embodiment, a higher-layer PDU carried by the first data unit belongs to a first PDU set.

In one subembodiment of the above embodiment, the first data unit is a first one of data units in the first PDU set.

In one subembodiment of the above embodiment, a higher-layer PDU carried by the first data unit is a first one of data units in the first PDU set.

In one subembodiment of the above embodiment, the meaning of the phrase of a first one of data units comprises: an earliest data unit.

In one subembodiment of the above embodiment, the meaning of the phrase of a first one of data units comprises: an earliest data unit to arrive.

In one subembodiment of the above embodiment, the meaning of the phrase of a first one of data units comprises: a data unit with a most preceding sequence number.

In one subembodiment of the above embodiment, the first data unit triggers executing a calculation of the first data volume.

In one subembodiment of the above embodiment, a reception, arrival, transmission or retransmission of the first data unit triggers executing a calculation of the first data volume.

In one subembodiment of the above embodiment, a size of the first data unit is used to determine the first adjustment amount.

In one subembodiment of the above embodiment, a sequence number corresponding to the first data unit is used to determine the first adjustment amount.

In one subembodiment of the above embodiment, a flow to which the first data unit belongs is used to determine the first adjustment amount.

In one subembodiment of the above embodiment, whether the first data unit belongs to a specific flow is used to determine the first adjustment amount.

In one subembodiment of the above embodiment, whether the first data unit belongs to a specific session is used to determine the first adjustment amount.

In one subembodiment of the above embodiment, a field of a header of the first data unit is used to determine the first adjustment amount.

In one subembodiment of the above embodiment, a type of a header of the first data unit is used to determine the first adjustment amount.

In one subembodiment of the above embodiment, QoS information of the first data unit is used to determine the first adjustment amount.

In one subembodiment of the above embodiment, an arrival time of the first data unit is used to determine the first adjustment amount.

In one subembodiment of the above embodiment, a transmission time of the first data unit is used to determine the first adjustment amount.

In one subembodiment of the above embodiment, a generation time of the first data unit is used to determine the first adjustment amount.

In one subembodiment of the above embodiment, a packet delay budget (PDB) of the first data unit is used to determine the first adjustment amount.

In one embodiment, the first data unit is a PDCP control PDU of a PDCP entity of the first node.

In one subembodiment of the above embodiment, accompanying a transmission of the first data unit, the first adjustment amount is determined.

In one subembodiment of the above embodiment, an improperly received PDU indicated by the first data unit is used to determine the first adjustment amount.

In one subembodiment of the above embodiment, a properly received PDU indicated by the first data unit is used to determine the first adjustment.

In one subembodiment of the above embodiment, a size of a properly received PDU indicated by the first data unit is used to determine the first adjustment.

In one subembodiment of the above embodiment, a field of the first data unit is used to indicate the first adjustment amount.

In one subembodiment of the above embodiment, a field of the first data unit is used to indicate whether an adjustment amount is used.

In one subembodiment of the above embodiment, a field of the first data unit is used to indicate whether a first adjustment amount is used.

In one embodiment, the first data unit is a PDCP control PDU received by the first node.

In one subembodiment of the above embodiment, an improperly received PDU indicated by the first data unit is used to determine the first adjustment amount.

In one subembodiment of the above embodiment, a properly received PDU indicated by the first data unit is used to determine the first adjustment amount.

In one subembodiment of the above embodiment, a size of a properly received PDU indicated by the first data unit is used to determine the first adjustment amount.

In one subembodiment of the above embodiment, a field of the first data unit is used to indicate the first adjustment amount.

In one subembodiment of the above embodiment, a field of the first data unit is used to indicate whether an adjustment amount is used.

In one subembodiment of the above embodiment, a field of the first data unit is used to indicate whether a first adjustment amount is used.

In one subembodiment of the above embodiment, a field of the first data unit is used to indicate a range of the first adjustment amount.

In one subembodiment of the above embodiment, a field of the first data unit is used to indicate a maximum value of the first adjustment amount.

### Embodiment 10

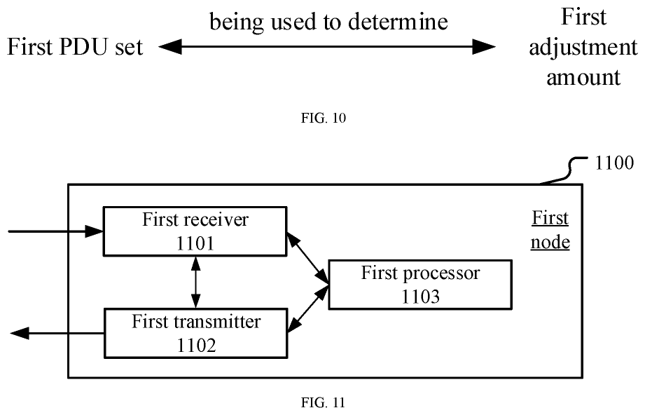

Embodiment 10 illustrates a schematic diagram of a first PDU set being used to determine a first adjustment amount according to one embodiment of the present application, as shown in FIG. 10.

In one embodiment, the first PDU set comprises a PDU of an IP layer.

In one embodiment, the first PDU set comprises a PDU of an NAS layer.

In one embodiment, the first PDU set comprises a PDU of an SDAP layer.

In one embodiment, the first PDU set comprises at least one PDCP PDU that has not yet arrived at the first node.

In one embodiment, the first PDU set comprises one of a PDCP SDU not constructed with a corresponding PDCP data PDU, a PDCP data PDU not submitted to a lower layer, a PDCP SDU of an AM DRB that will be retransmitted, and a PDCP data PDU of an AM DRB that will be retransmitted.

In one embodiment, the first PDU set does not comprise a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first PDU set comprises at least one PDU not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first PDU set does not comprise: a PDU of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first PDU set comprises a limited number of PDU(s).

In one embodiment, the first PDU set comprises a PDU before a first transmission time.

In one subembodiment of the above embodiment, the PDU before the first transmission time belongs to a same flow.

In one subembodiment of the above embodiment, the PDU before the first transmission time belongs to a same session.

In one subembodiment of the above embodiment, the PDU before the first transmission time belongs to a same bearer.

In one subembodiment of the above embodiment, the first PDU set comprises all PDUs before a first transmission time.

In one subembodiment of the above embodiment, the first PDU set comprises all data PDUs before a first transmission time.

In one embodiment, the first PDU set belongs to a same flow.

In one embodiment, the first PDU set belongs to multiple flows.

In one embodiment, PDUs in the first PDU set have a dependency relation with each other.

In one embodiment, PDUs in the first PDU set are associated with a specific time.

In one embodiment, PDUs in the first PDU set are associated with a first transmission time.

In one embodiment, at least one PDU other than a first PDU in the first PDU set depends on a reception of the first PDU.

In one subembodiment of the above embodiment, whether a header identity of a PDU in the first PDU set depends on other PDUs.

In one embodiment, PDUs in a first PDU set have different QoSs.

In one embodiment, the first QoS information is used to determine the first PDU set.

In one embodiment, the first adjustment amount only comprises a data volume of data in the first PDU set.

In one embodiment, the first adjustment amount is related to a PDU comprised in the first PDU set not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first adjustment amount comprises a data volume of a PDU comprised in the first PDU set not belonging to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, the first adjustment amount comprises calculating a PDCP data volume of a PDCP entity other than a PDCP entity of the first data volume.

In one subembodiment of the embodiment, the PDCP entity calculating the first data volume and the PDCP entity other than a PDCP entity calculating the first data volume are associated with a same MAC.

In one embodiment, a protocol layer above a PDCP layer of the first node indicates the first PDU set.

In one embodiment, the meaning of the phrase that a protocol layer above a PDCP layer of the first node indicates the first PDU set comprises: the protocol layer above a PDCP layer of the first node indicates a data volume of the first PDU set.

In one embodiment, the meaning of the phrase that a protocol layer above a PDCP layer of the first node indicates the first PDU set comprises: the protocol layer above a PDCP layer of the first node indicates a number of PDU(s) in the first PDU set.

In one embodiment, the first PDU set comprises PDUs or all possible PDUs within a first time window.

In one embodiment, any PDU comprised in the first PDU set belongs to a PDU of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted.

In one embodiment, any PDU comprised in the first PDU set is a PDCP data PDU.

In one embodiment, any PDU comprised in the first PDU set is a data PDU.

In one embodiment, the first QoS information is used to determine a first time length, and a length of the first time window is the first time length.

In one embodiment, a second time window is a time window with a length of the first time length, and an end time of the second time window is a start time of the first time window.

In one embodiment, a number of SDU(s) or PDU(s) of a PDCP transmitted in the second time window is used to estimate a number or data volume of PDU(s) comprised in the first PDU set.

In one embodiment, a data volume of SDU(s) or PDU(s) of a PDCP transmitted in the second time window is used to estimate a data volume or a number of PDU(s) of the first PDU set.

In one embodiment, a data volume of SDU(s) of a PDCP arrived in the second time window is used to estimate a data volume of the first PDU set.

In one embodiment, a number of SDU(s) of a PDCP arrived in the second time window is used to estimate a data volume of the first PDU set.

In one embodiment, the first adjustment amount comprises a data volume of the first PDU set.

In one embodiment, the first adjustment amount comprises a pre-estimated data volume of the first PDU set.

In one embodiment, the first adjustment amount is a smaller one of a data volume and a threshold of the first PDU set.

### Embodiment 11

Embodiment 11 illustrates a structure block diagram of a processor in a first node according to one embodiment of the present application, as shown in FIG. 11. In FIG. 11, a processor 1100 in a first node comprises a first receiver 1101, a first transmitter 1102 and a first processor 1103. In Embodiment 11,
the first processor 1103 calculates a first data volume in a PDCP;
the first transmitter 1102 transmits a first BSR;
herein, the first data volume is used for the first BSR; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment amount is used to determine the first data volume.

In one embodiment, the first adjustment amount is unrelated to both a PDCP SDU and a PDCP PDU in buffer.

In one embodiment, what is included in the first adjustment amount comprises higher-layer data not having arrived at a PDCP.

In one embodiment, at least one of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is used to determine the first adjustment amount.

In one embodiment, the first receiver 1101 receives a first signaling, and the first signaling indicates a first sequence number threshold;
herein, a first PDCP data unit is a last PDCP data unit to be allocated a sequence number, a sequence number of the first PDCP data unit is a first sequence number, and the first adjustment amount comprises a data volume of a PDCP data unit not exceeding the first sequence number threshold after the first sequence number.

In one embodiment, the first receiver 1101 receives a first signaling, and the first signaling indicates a first data volume threshold;
herein, the first adjustment amount comprises a data volume not exceeding the first data volume threshold.

In one embodiment, a first PDCP data unit is a latest PDCP data unit, a sequence number of the first PDCP data unit is a first sequence number, the first adjustment amount comprises a data volume of K PDCP data unit(s) after the first sequence number, where K is a positive integer, and a value of K is related to a value of the first sequence number, when a value of the first sequence number increases, a value of K decreases.

In one embodiment, the first receiver 1101 receives first QoS information, and the first QoS information is for interactive services; the first QoS information is used to determine a first transmission time, and the first adjustment amount comprises an expected data volume of a PDCP data unit before the first transmission time.

In one embodiment, the first transmission time is related to a next running of an onduration timer of a DRX.

In one embodiment, a protocol layer above a PDCP of the first node indicates a first PDU set, and the first PDU set is used to determine the first adjustment amount; the first PDU set comprises at least one PDU unrelated to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted; the meaning of the phrase that a protocol layer above a PDCP of the first node indicates a first PDU set comprises: a protocol layer above a PDCP of the first node indicates a number of PDU(s) comprised in the first PDU set, or a protocol layer above a PDCP of the first node indicates a data volume of the first PDU set.

In one embodiment, the first receiver 1101 receives first scheduling information;
the first transmitter 1102, on resources indicated by the first scheduling information, transmits a first PDCP PDU set; the first PDCP PDU set comprises at least a first PDCP PDU;
herein, a header of the first PDCP PDU comprises a first field and a second field, the first field indicates a sequence number of the first PDCP PDU, and the second field is used to indicate whether the first PDCP PDU belongs to a PDU set.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things (IoT) terminal or an Industrial Internet of Things (IIoT) terminal.

In one embodiment, the first node is a device that supports transmission with low-latency and high-reliability.

In one embodiment, the first node is a sidelink communication node.

In one embodiment, the first node is a base station.

In one embodiment, the first node is a satellite.

In one embodiment, the first node is an access network.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first processor, calculating a first data volume in a Packet Data Convergence Protocol (PDCP); and
a first transmitter, transmitting a first buffer status report;
wherein the first data volume is used for the first buffer status report; any of a PDCP Service Data Unit (SDU) not constructed with a corresponding a PDCP data Protocol Data Unit (PDU), a PDCP data PDU not submitted to a lower layer, a PDCP control PDU, a PDCP SDU of an Acknowledged Mode Data Radio Bearer (AM DRB) that will be retransmitted, and a PDCP data PDU of an AM DRB that will be retransmitted is included in only a former of the first data volume and a first adjustment amount, and the first adjustment is used to determine the first data volume.

2. The first node according to claim 1, wherein
the first adjustment amount is unrelated to both a PDCP SDU and a PDCP PDU in buffer.

3. The first node according to claim 1, wherein
what is included in the first adjustment amount comprises higher-layer data not having arrived at a PDCP.

4. The first node according to claim 2, wherein
what is included in the first adjustment amount comprises higher-layer data not having arrived at a PDCP.

5. The first node according to claim 1, wherein
at least one of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is used to determine the first adjustment amount.

6. The first node according to claim 1, comprising:
a first receiver, receiving a first signaling, the first signaling indicating a first sequence number threshold;
wherein a first PDCP data unit is a last PDCP data unit to be allocated a sequence number, a sequence number of the first PDCP data unit is a first sequence number, and the first adjustment amount comprises a data volume of a PDCP data unit not exceeding the first sequence number threshold after the first sequence number.

7. The first node according to claim 3, comprising:
a first receiver, receiving a first signaling, the first signaling indicating a first sequence number threshold;
wherein a first PDCP data unit is a last PDCP data unit to be allocated a sequence number, a sequence number of the first PDCP data unit is a first sequence number, and the first adjustment amount comprises a data volume of a PDCP data unit not exceeding the first sequence number threshold after the first sequence number.

8. The first node according to claim 1, comprising:
a first receiver, receiving a first signaling, the first signaling indicating a first data volume threshold;
wherein the first adjustment amount comprises a data volume not exceeding the first data volume threshold.

9. The first node according to claim 1, wherein
a first PDCP data unit is a latest PDCP data unit, a sequence number of the first PDCP data unit is a first sequence number, the first adjustment amount comprises a data volume of K PDCP data unit(s) after the first sequence number, where K is a positive integer, and a value of K is related to a value of the first sequence number, when a value of the first sequence number increases, a value of K decreases.

10. The first node according to claim 7, wherein
a first PDCP data unit is a latest PDCP data unit, a sequence number of the first PDCP data unit is a first sequence number, the first adjustment amount comprises a data volume of K PDCP data unit(s) after the first sequence number, where K is a positive integer, and a value of K is related to a value of the first sequence number, when a value of the first sequence number increases, a value of K decreases.

11. The first node according to claim 1, comprising:
a first receiver, receiving first Quality of Service (QoS) information, the first QoS information being for interactive service; the first QoS information being used to determine a first transmission time, and the first adjustment amount comprising an expected data volume of a PDCP data unit before the first transmission time.

12. The first node according to claim 4, comprising:
a first receiver, receiving first QoS information, the first QoS information being for interactive service; the first QoS information being used to determine a first transmission time, and the first adjustment amount comprises an expected data volume of a PDCP data unit before the first transmission time.

13. The first node according to claim 12, wherein
the first QoS information comprises a first QoS parameter, and the first QoS parameter comprised in first QoS information has a mapping relation with a group of QoS characteristics; the group of QoS characteristics comprises: pose-to-render-to-photon time and time delay jitter.

14. The first node according to claim 11, wherein
the first transmission time is related to a next running of an onduration timer of a Discontinuous Reception (DRX).

15. The first node according to claim 1, wherein
a protocol layer above a PDCP of the first node indicates a first PDU set, and the first PDU set is used to determine the first adjustment amount; the first PDU set comprises at least one PDU unrelated to a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted; the meaning of the phrase that a protocol layer above a PDCP of the first node indicates a first PDU set comprises: a protocol layer above a PDCP of the first node indicates a number of PDU(s) comprised in the first PDU set, or a protocol layer above a PDCP of the first node indicates a data volume of the first PDU set.

16. The first node according to claim 15, wherein
PDUs in the first PDU set have a dependency relation with each other, and the PDUs in the first PDU set are associated with a specific time.

17. The first node according to claim 16, wherein
the first adjustment amount comprises an estimated data volume of the first PDU set.

18. The first node according to claim 1, comprising:
a first receiver, receiving first scheduling information; and
the first transmitter, on resources indicated by the first scheduling information, transmitting a first PDCP PDU set; the first PDCP PDU set comprises at least a first PDCP PDU;
wherein a header of the first PDCP PDU comprises a first field and a second field, the first field indicates a sequence number of the first PDCP PDU, and the second field is used to indicate whether the first PDCP PDU belongs to a PDU set.

19. The first node according to claim 2, comprising:
a first receiver, receiving first scheduling information; and
the first transmitter, on resources indicated by the first scheduling information, transmitting a first PDCP PDU set; the first PDCP PDU set comprises at least a first PDCP PDU;
wherein a header of the first PDCP PDU comprises a first field and a second field, the first field indicates a sequence number of the first PDCP PDU, and the second field is used to indicate whether the first PDCP PDU belongs to a PDU set.

20. A method in a first node for wireless communications, comprising:
calculating a first data volume in a PDCP; and
transmitting a first buffer status report;
wherein the first data volume is used for the first buffer status report; any of a PDCP SDU not constructed with a corresponding PDCP data PDU, a PDCP data PDU not submitted to a lower layer, a PDCP control PDU, a PDCP SDU of an AM DRB that will be retransmitted, and a PDCP data PDU of an AM DRB that will be retransmitted is included in only a former of the first data volume and a first adjustment amount, and the first adjustment is used to determine the first data volume.
